(19) United States
(12) Patent Application Publication
(10) Pub. No.: US 2018/0132622 A1
(43) Pub. Date: May 17, 2018

(54) CHAIR SYSTEMS AND METHOD

(71) Applicant: Yi Yan Wu, Markham (CA)

(72) Inventor: Yi Yan Wu, Markham (CA)

(21) Appl. No.: 15/351,641

(22) Filed: Nov. 15, 2016

(51) Int. Cl. A47C 7/52; B60N 3/06; B64D 11/06; A47C 7/50; B60N 2/46; B60N 2/64

(52) U.S. Cl. CPC A47C 7/52; B60N 3/063; B60N 2/64; A47C 7/506; B60N 2/46; B64D 11/0646

(57) ABSTRACT

A chair system and method; the chair system includes a chair assembly having a body including a seat portion, a sheet attachment, a leg-support member, at least one leg, and a seat-fastener. The chair assembly is useful for removably coupling to a seat and supporting a user in a comfortable position.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of chairs and more specifically relates to a portable chair system.

### 2. Description of Related Art

Travelling has become a very common part of life, whether it is for work, visiting friends or family or for a vacation. People often travel for long periods during which time they are seated in a chair and are generally sedentary. In particular, traveling on airplanes requires a passenger to be seated in a cramped position for many hours. Travelling in trains, buses and the like can also see a passenger seated for long periods of time in awkward and uncomfortable positions. A suitable solution is desired.

U.S. Pat. No. 7,954,900 to Totada R. Shantha et al. relates to a leg supporting device for use behind a head rest for air and vehicular travel. The described leg supporting device for use behind a head rest for air and vehicular travel includes a leg supporting device for use behind a head rest for air and vehicular travel having a head rest support portion that fits over a head rest of a forwardly positioned seat and supports a back flap portion that hangs down behind the forwardly positioned seat. A pair of adjustment straps adjustably attach to the back flap portion and supports a foot support portion. A user slips one or both of their feet into the foot support portion and then adjusts the adjustment straps to support their feet at a desired height and position. The foot support portion handles to carry it. In use, the leg supporting device can be folded and placed within the foot support portion and carried using the handles until needed. One embodiment includes pockets for holding drinks, computer, and other carry-on items. A leg massage unit may be built in for additional relief.

### BRIEF SUMMARY OF THE INVENTION

In view of the foregoing disadvantages inherent in the known chair and accessory art, the present disclosure provides a novel chair system and method. The general purpose of the present disclosure, which will be described subsequently in greater detail, is to provide a chair system and method.

A chair system is disclosed herein. The chair system includes a chair assembly including a body having a seat portion, a leg-support member, and at least one leg, and a seat-fastener.

According to another embodiment, a chair system is also disclosed herein. The chair system and method includes a chair assembly including a body having a seat portion, a sheet cover, leg-support member, and at least one leg, and a seat-fastener. According to this embodiment, the chair system comprises the chair assembly. The chair assembly comprises the body. The body comprises the leg-support member, a sheet cover, the seat portion, and the seat-fastener in functional combination. The body is flexible and comprises fabric for comfort and support. The fabric is similar to a foldable lawn chair.

The seat portion may include an inflatable insert for supporting the user and reducing undesired movement during use. The inflatable insert is designed to prevent an infant or child from rolling off the seat when moving while sleeping. The leg-support member is fastened via fasteners to a second-end of the seat portion. The leg-support member comprises at least one leg for supporting legs of a user while sitting or lying down for extended periods of time. The leg-support member is collapsible for storage. The legs include pivoting features to fold in a manner similar to a foldable lawn chair. The leg-support member preferably comprises four adjustable legs. The legs may be manufactured using light-weight material for portability and durability. The legs may have base members for support against a planar surface such as the floor in a plane or vehicle. The base members may further include gripping members (means) to reduce undesired movement.

The seat-fastener is located at a first-end of the removable sheet portion. The leg-support member is fastened via the fasteners to a second-end of the seat portion when the sheet is attached to the portable chair. The fasteners may comprise elastic or other suitable materials. The chair assembly is fastened to a seat via the seat-fastener. The chair assembly is useful for removably coupling to a (host) seat and supporting a user in a comfortable position. The seat is selected from a group of airplane-seats and vehicle-seats. Other seats may be used. The chair assembly comprises about a width of the seat. The at least one leg comprises a height of the seat to support legs of the user in a laying down position. The seat-fastener comprises fastening means for coupling to the seat and supporting the user in a comfortable legs-extended-position.

According to another embodiment, a chair system and method is also disclosed herein. The chair system and method includes step one, placing a seat portion ontop of a seat, attaching the comfort sheet attachment on top of the chair to the host seat, resting legs on leg-support member, collapsing at least one leg of a leg-support member for storage, and storing chair assembly.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a chair system and method, constructed and operative according to the teachings of the present disclosure.

FIG. 1 is a perspective view of the chair system and method during an ‘in-use’ condition, according to an embodiment of the disclosure.

FIG. 2 is a perspective view of the chair assembly of FIG. 1, according to an embodiment of the present disclosure.

FIG. 3 is a perspective view of the chair assembly of FIG. 1, according to an embodiment of the present disclosure.

FIG. 4 is a flow diagram illustrating a method of use for the chair system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a chair accessory and more particularly to a chair system and method as used to improve the comfort and support of legs of a user during extended periods of sitting.

Generally, chair system and method. The present invention comprises a leg-support member having a similar but novel function as to an outdoor folding chair. The leg-support member includes pivoting legs that are collapsible for portability and easy storage. The device may function as a lie down bed for children when traveling on an airplane or in a vehicle for extended periods of time. The height of the chair system matches the height from the ground to an air plane seat. Adults may use the device for leg support as well. The chair system may further include an additional soft chair top attachment when being used on an airplane for children to sleep on. The chair system also reduces the chance of kids falling down or off a seat when turning their bodies while resting or sleeping. The device provides additional comfort for longer sleeping time.

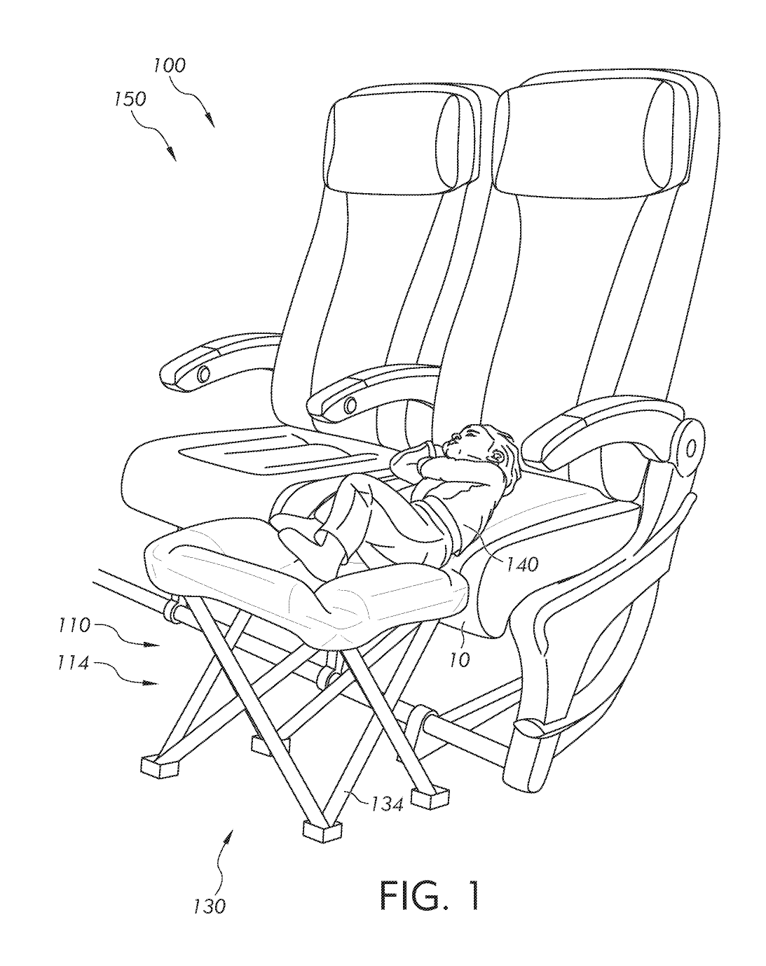

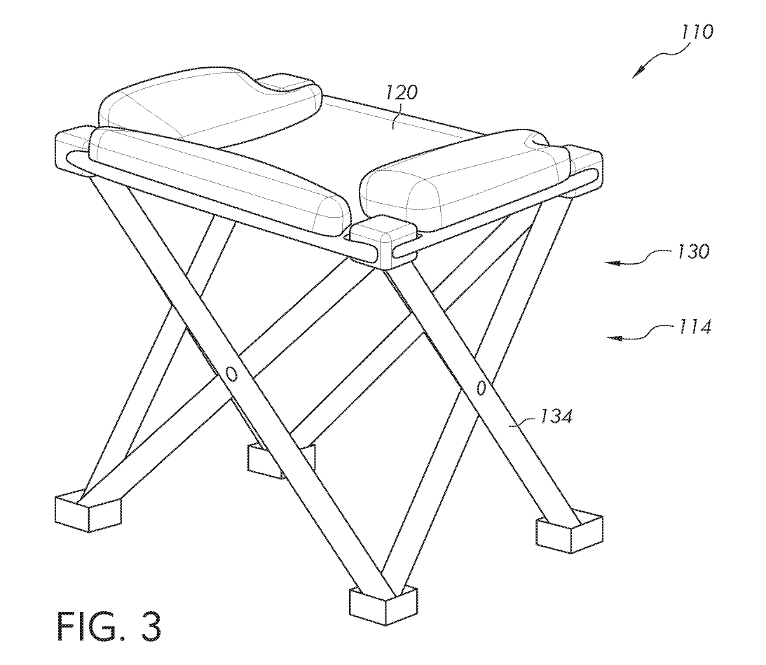

Referring now more specifically to the drawings by numerals of reference, there is shown in FIGS. 1-3, various views of a chair system and method 100. FIG. 1 shows a chair system and method during an ‘in-use’ condition 150, according to an embodiment of the present disclosure. Here, the chair system and method 100 may be beneficial for use by a user 140 to provide comfort and leg support for user 140. As illustrated, the chair system and method 100 may include body 114 having seat portion 120, sheet cover 124, leg-support member 130; and at least one leg 134, and comfort sheet attachment 160.

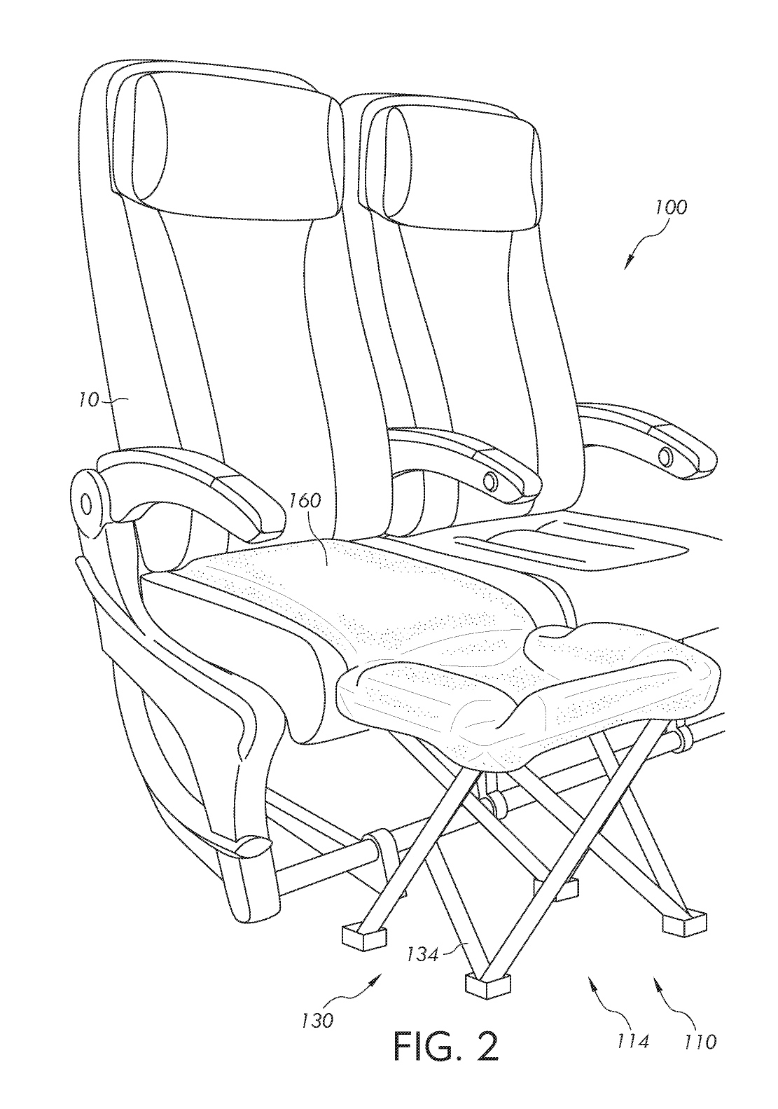

FIG. 2 shows chair system and method 100 of FIG. 1, according to an embodiment of the present disclosure. As above, the chair system and method 100 may include body 114 having seat portion 120, sheet cover 124, leg-support member 130, and at least one leg 134, and comfort sheet attachment 160. Chair system 100 comprises chair assembly 110. Chair assembly comprises 110 body 114. Body 114 comprises sheet cover 124, leg-support member 130, seat portion 120, and comfort sheet attachment 160 in functional combination. Sheet cover 124, is removably coupleable to seat portion 120 and extends to seat 10. Shown in FIG. 2 is leg-support member 130 comprising at least one leg 134 for supporting user 140. Leg-support member 130 is fastened via fasteners to a second-end of seat portion 120. Seat-fastener 160 is located on top of seat portion 120. Chair assembly 110 is fastened to seat 10 of an airplane, a car or other vehicle via seat-fastener at the end of comfort sheet attachment 160 if desired. Chair assembly 110 is useful for removably coupling to seat 10 and supporting user 140 in a comfortable position.

Leg-support member 130 is fastened via the fasteners to a second-end of seat portion 120. Fasteners may comprise rope or elastic. Leg-support member 130 may have four legs comprising light-weight material for portability. Body 114 of chair system 100 is flexible and comprises fabric. Leg-support member 130 is collapsible for storage. At least one leg is adjustable 134. At least on leg 134 comprises base members for support against a planar surface such as a floor of a plane or a car. Seat 10 is selected from a group of airplane-seats and vehicle-seats. Chair assembly 110 comprises a width of seat 10. At least one leg 134 comprises a height of seat 10 to support legs of user 140 in a laying down or sitting position. Seat portion 120 includes an inflatable insert for supporting user 140 and reducing undesired movement during use. The inflatable insert is designed to reduce the risk of a child falling from the chair system while rolling around while sleeping. Seat-fastener comprises fastening means for coupling to seat 10 and supporting user 140 in a comfortable legs-extended-position. The invention may comprise a frame including pairs of front crossed legs and rear crossed legs, and two pairs of side crossed legs, with each pair of crossed legs being pivotally connected together where they cross. Base members may be connected to the legs lower ends. The legs may be pivotally connected to allow for folding and storing the leg-support member.

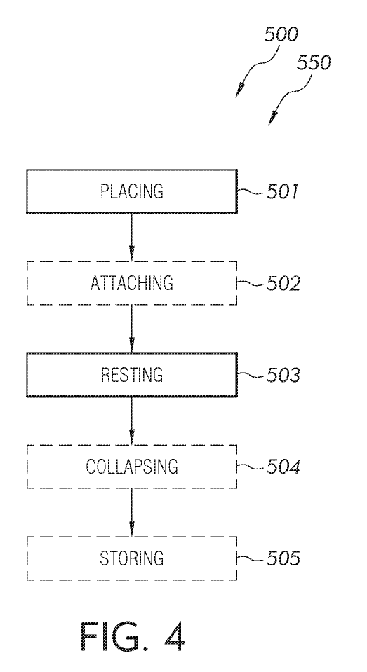

FIG. 4 is a flow diagram illustrating a method 400 for supporting legs of a user, 140 according to an embodiment of the present disclosure. In particular, the method for supporting legs of a user 140 may include one or more components or features of the chair system and method 100 as described above. As illustrated, the method for supporting legs of a user 140 may include the steps of: step one 501, placing comfort sheet attachment 160 on top of seat 10; step two 502, attaching the comfort sheet attachment 160 on top of the host seat 10; step three 503, resting legs on leg-support member 130; step four 504, collapsing at least one leg 134 of a leg-support member 130 for storage; and step five 505, storing chair assembly 110.

It should be noted that step two 502, steps four 504, and five 505 are optional steps and may not be implemented in all cases. Optional steps of method of use 500 are illustrated using dotted lines in FIG. 4 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for supporting a user 140 while sitting for extended periods of time (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A chair system, the chair system comprising:
a chair assembly including;
a body having;
a seat portion;
a sheet attachment;
a leg-support member; and
at least one leg;
wherein said chair system comprises said chair assembly;
wherein said chair assembly comprises said body;
wherein said body comprises said leg-support member, said seat portion, said a sheet attachment, and said seat-fastener in functional combination;
wherein said sheet attachment is coupleable to said seat portion and extends to said seat;
wherein said leg-support member comprises at least one leg for supporting a user;
wherein said leg-support member is fastened via fasteners to a second-end of said seat portion;
wherein said chair assembly is fastened to a seat via said seat-fastener; and
wherein said chair assembly is useful for removably coupling to a seat and supporting a user in a comfortable position.

2. The chair system and method of claim 1, wherein said fasteners comprise rope.

3. The chair system and method of claim 1, wherein said fasteners comprise elastic.

4. The chair system and method of claim 1, wherein said leg-support member is fastened via said fasteners from said sheet attachment to a second-end of said seat portion.

5. The chair system and method of claim 1, wherein said leg-support member comprises four of said legs.

6. The chair system and method of claim 1, wherein said at least one leg comprises light-weight material for portability.

7. The chair system and method of claim 1, wherein said body is flexible.

8. The chair system and method of claim 1, wherein said body comprises fabric.

9. The chair system and method of claim 1, wherein said leg-support member is collapsible for storage.

10. The chair system and method of claim 1, wherein said at least one leg is adjustable.

11. The chair system and method of claim 1, wherein said at least on leg comprises base members for support against a planar surface.

12. The chair system and method of claim 1, wherein said seat is selected from a group of airplane-seats and vehicle-seats.

13. The chair system and method of claim 1, wherein said chair assembly comprises a width of said seat.

14. The chair system and method of claim 1, wherein said at least one leg comprises a height of said seat to support legs of said user in a laying down position.

15. The chair system and method of claim 1, wherein said seat portion includes an inflatable insert for supporting said user and reducing undesired movement during use.

16. The chair system and method of claim 1, wherein said sheet attachment comprises fastening means for coupling to said seat and supporting said user in a comfortable legs-extended-position.

17. A chair system and method, the system comprising:
a chair assembly including;
a body having;
a seat portion;
a sheet attachment;
a leg-support member; and
at least one leg; and
wherein said chair system comprises said chair assembly;
wherein said chair assembly comprises said body;
wherein said body comprises said leg-support member, said seat portion, and said sheet attachment in functional combination;
wherein said body is flexible;
wherein said body comprises fabric;
wherein said sheet attachment is coupleable to said seat portion and extends to a seat;
wherein said seat portion includes an inflatable insert for supporting said user and reducing undesired movement during use;
wherein said leg-support member is fastened via fasteners to a second-end of said seat portion;
wherein said leg-support member comprises at least one leg for supporting a user;
wherein said leg-support member is collapsible for storage;
wherein said leg-support member comprises four of said legs;
wherein said at least one leg comprises light-weight material for portability;
wherein said at least one leg is adjustable;
wherein said at least on leg comprises base members for support against a planar surface;
wherein said seat-fastener is located at a first-end of said seat portion;
leg-support member is fastened via said fasteners to a second-end of said seat portion;
wherein said fasteners comprise elastic;
wherein said chair assembly is fastened to a seat via said seat-fastener;
wherein said chair assembly is useful for removably coupling to a seat and supporting a user in a comfortable position;
wherein said seat is selected from a group of airplane-seats and vehicle-seats;
wherein said chair assembly comprises a width of said seat;
wherein said at least one leg comprises a height of said seat to support legs of said user in a laying down position; and
seat-fastener comprises fastening means for coupling to said seat and supporting said user in a comfortable legs-extended-position.

18. The system of claim 17, further comprising set of instructions; and
wherein the system is arranged as a kit.

19. A chair system and method, the method comprising the steps of:
placing a comfort sheet attachment on top of a seat; and
resting legs on a leg-support member

20. The method of claim 19, further comprising the steps of:
attaching said comfort sheet attachment on top of said host seat;
collapsing said at least one leg of a leg-support member for storage; and
storing said chair assembly.
